(19) United States
(12) Patent Application Publication
(10) Pub. No.: US 2026/0129271 A1
(43) Pub. Date: May 7, 2026

(54) Analog-to-Digital Wireless Gauge Reader

(71) Applicant: Entergy Corporation, New Orleans, LA (US)

(72) Inventors: Jacob Michael Claes, Madison, MS (US); Julio Eduardo Diaz, Brandon, MS (US); Billie Wayne Henstley, Dover, AR (US)

(21) Appl. No.: 18/935,233

(22) Filed: Nov. 1, 2024

(51) Int. Cl. H04N 7/18; H04N 23/51

(52) U.S. Cl. CPC H04N 23/51

(57) ABSTRACT

A wireless gauge reader with a central body and legs mounts over an analog gauge in such a way that it does not block physical reading of the gauge face itself. The reader uses an algorithm developed to perform image extraction in order to convert the analog hardware reading to a digital data value. The telescoping feature of the device itself allows the device to be mounted on a wide range of gauge diameters, and the leg contraction system allows a synchronous movement of the legs that converge onto the perimeter of the gauge. The device can perform near real-time reading, and consume relatively low energy while it is asleep in order to maintain battery longevity. The device does not block direct visual reading of the analog gauge, thereby allowing for compliance with applicable regulations in certain industries.

### BACKGROUND OF THE INVENTION

Most of the plants forming the American Nuclear Power Plant (NPP) fleet were constructed in the time period between 1970 to 1996. At the time, these engineering marvels were an example of state-of-the-art technology, much of it being reliable analog in nature. Unfortunately, the industry did not keep up the pace with the significant technological advancements over the past twenty years, particularly the digital revolution. As a result, much of the technology has become obsolete, and the operations of NPP's remains manually intensive and outdated. The same problem exists in a number of other industries, with vast quantities of analog gauges still in use that require constant monitoring by personnel who must physically be present at the location of the gauge in order to record a reading.

As NPPs move into the digital age, increases to monitoring capabilities is a vital first step. However, many of the analog indicators located throughout the NPP are read by operations personnel during regulatory required rounds. Unfortunately, this data collection can become a distraction to operations teams and are not performed on a high enough frequency to get the granularity necessary to perform maintenance predictions and performance optimization. Additionally, regulations applicable to the nuclear industry require decisions to be made from the non-wireless indications, which are often analog, so it is vitally important that any technological solutions not hinder this, nor tempt personnel to forego reading of the analog gauge in person as required by regulation. Moreover, the cost to replace the analog indicator with a digital variant is cost prohibitive, in the nuclear field and in many other fields as well.

### SUMMARY OF THE INVENTION

The invention is directed to a wireless gauge reader, which uses an algorithm developed to perform image extraction in order to convert the reading from the analog hardware to a digital data value. In certain embodiments, the telescoping feature of the wireless gauge reader itself allows the device to be mounted on a wide range of gauge diameters, and the leg contraction system allows a synchronous movement of the legs that converge onto the perimeter of the gauge for secure mounting. The device in such embodiments can perform near real-time reading, and consume relatively low energy while it is asleep in order to maintain battery longevity. In certain embodiments, the device is powered from off-the-shelf batteries, eliminating the concern of proprietary battery technology which can be otherwise costly.

Ultimately, the readings from this device in certain embodiments can be used to decrease the time burden that nuclear power plant operators undergo to collect data from the analog hardware to satisfy regulatory requirements. Additionally, the relatively low-cost implementation of these devices according to certain embodiments provide an alternative option to obtain the data in a digital format for remote monitoring purposes. This allows the construction of more complex models through the remote monitoring centers for operational predictability and equipment health trending. Furthermore, this technology can be beneficial to any industrial setting which deploys analog hardware and is not able to deploy digital hardware due to its high cost.

Therefore, an object of the invention is to reduce operator burden from data collection.

A further object of the invention is to provide data-driven operational performance improvement and maintenance optimization.

A still further object of the invention is to not visually obstruct analog gauge indications, so that those gauges may still be read in a conventional fashion as and if required by applicable laws, regulations, rules, or best practices.

These and other features, objects and advantages of the present invention will become better understood from a consideration of the following detailed description of the preferred embodiments and appended claims in conjunction with the drawings as described following:

### BRIEF DESCRIPTION OF DRAWINGS

FIG. 1A is a perspective view of a device according to an embodiment of the present invention.

FIG. 1B is a detail view inside the housing cap of a device according to an embodiment of the present invention.

FIG. 1C is a detail view of the camera aperture of a device according to an embodiment of the present invention.

FIG. 1D is a detail view showing engagement between a leg cam and the leg adjustment ring according to an embodiment of the present invention.

FIG. 2 shows an analog gauge with calibration points added according to an embodiment of the present invention.

FIG. 3 show an analog gauge image with an applied mask according to an embodiment of the present invention.

FIG. 4 shows an analog gauge image for application of the minimum calibration point and maximum calibration point subroutine according to an embodiment of the present invention.

FIG. 5 shows a first method of detecting radial-edge intercepts on an analog gauge according to an embodiment of the present invention.

FIG. 6A is a diagram illustrating radial and angular sampling according to an embodiment of the present invention.

FIG. 6B shows detected radial-edge intercepts on an analog gauge according to an embodiment of the present invention.

FIG. 7 is a graph of angle versus counts in an example pixel detection edge result according to an embodiment of the present invention.

FIG. 8 is a flow chart showing the image processing flow according to an embodiment of the present invention.

FIG. 9 is a diagram showing the architecture of a microcontroller as may be used to implement an embodiment of the present invention.

### DETAILED DESCRIPTION OF THE INVENTION

Before the present invention is described in further detail, it should be understood that the invention is not limited to the particular embodiments described, and that the terms used in describing the particular embodiments are for the purpose of describing those particular embodiments only, and are not intended to be limiting, since the scope of the present invention will be limited only by the claims.

In an embodiment, the wireless gauge reader is comprised of a housing 10 with three telescoping legs 16 connected to the upper plenum of the housing 10. These components may be 3D-printed, although the invention is not so limited. Although three telescoping legs 16 are shown in this embodiment, a different number of telescoping legs 16 could be used in alternative embodiments.

Housing 10 is designed to accommodate microcontroller 34 and camera 18. In certain embodiments, housing 10 has enough physical space to be adjusted to different micro-controller/camera chip sizes. Microprocessors or other types of processing units may be used in place of a microcontroller in alternative embodiments. The housing has a leg adjustment ring 14 on the underside of housing 10 that controls the articulation of the legs concurrently. In alternative embodiments, leg adjustment ring 14 can be fitted on the top side of housing 10 to accommodate different use cases.

Each leg 16 is divided into an upper leg 22 and lower leg 24. These two sections of each leg 16 are connected by locking nut 26. Manipulation of locking nut 26 allows for adjustment the total length of each leg 16 by loosening locking nut 26, sliding lower leg 24 downward and outward with respect to upper leg 22, and then tightening locking nut 26. This is part of the mechanism that allows the device to be adjusted for different sizes of gauges. In alternative embodiments, each leg 16 may be subdivided into a different number of sections.

Leg adjustment ring 14 controls the articulation of the three telescoping legs 16 concurrently, which allows for the legs 16 to spread outward or be drawn inward. This portion of the mechanism also is implemented to accommodate different sizes of gauges to which it can securely be mounted. The length of each of legs 16 and the travel of leg adjustment ring 14 contribute to the maximum and minimum diameter of gauge that may be accommodated by the device, and may be adjusted accordingly in alternative embodiments of the invention.

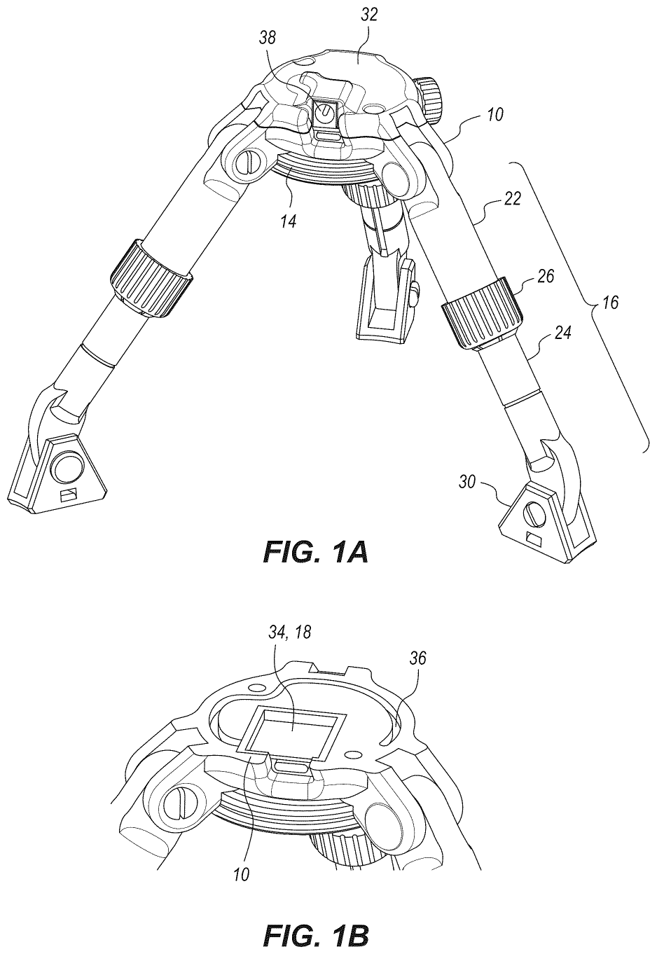

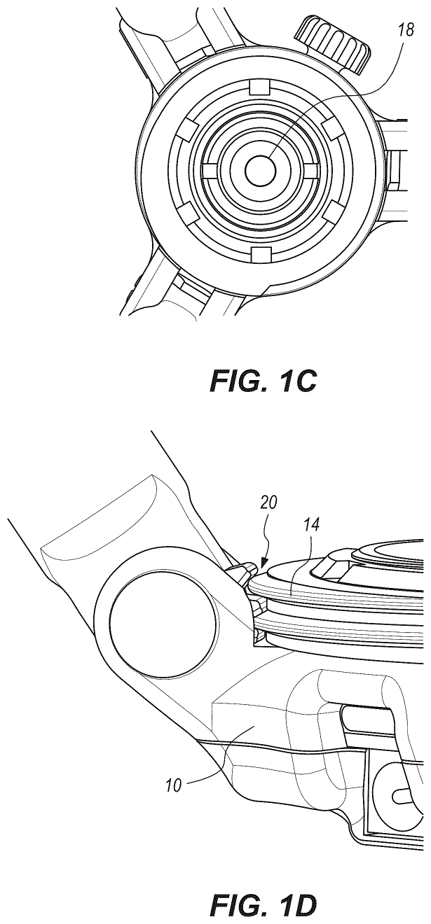

As best shown in FIG. 1D, each upper leg 22 features a leg cam 20 that extends inwardly toward and engaging with leg adjustment ring 14. By turning leg adjustment ring 14 with respect to housing 10, leg adjustment ring 14 moves upward or downward. This movement, due to its engagement with leg cams 20, causes legs 16 to move outward or inward with respect to housing 10. Upper legs 22 are hinged to housing 10, as best shown in FIG. 1A, to allow this outward or inward movement.

A foot 30, at the end of each lower leg 24, engages with the edge of the gauge that is to be read by the device. By tightening leg adjustment ring 14 once each foot 30 is in place at the sides of the gauge, the device is locked securely in place by the engagement between feet 30 and the gauge itself. It may be noted that, once the device is locked in place in this fashion, the analog gauge is still readable manually because the device does not block the face of the gauge; instead, the device sits above the center of the gauge.

Leg adjustment mechanism 14 includes an aperture for the camera 18 mounted on the micro-controller. This provides a clear view of the gauge to camera 18. The camera 18 is protected from weather conditions by a window 28 that is seated in the inner region of leg adjustment mechanism 14, as best shown in FIG. 1C.

Housing cap 32 is fitted into place on housing 10 to protect the internal components within housing 10 from the weather. When housing cap 32 is removed, access is provided to microcontroller 34 within housing 10. In some implementations, microcontroller 34 and camera 18 may be integrated into a single unit. In particular implementations, microcontroller 34 may be a commercial off-the-shelf microcontroller or microprocessor product.

Microcontroller 34 has a voltage regulator within housing 10 that adjusts to the microcontroller's input voltage. The voltage to the regulator is supplied by a battery pack (not shown) outside of housing 10. The battery pack may be of any desired type, including off-the-shelf battery types in order to reduce the cost of operation of the device. According to certain embodiments, the microcontroller 34 may be configured to enter a sleep mode when not actively engaged in gauge reading, in order to save battery life and thereby reduce the overall cost of operation for the device.

Removal of housing cap 32 also provides access to antenna channel 36, which housing an antenna (not shown but fitted within antenna channel 36) in order to provide for wireless communication with the device. The antenna within antenna channel 36 is connected to microcontroller 34.

Housing 10 also provides a connection port 38, allowing direct wired connections between microcontroller 34 within housing 10 to external devices for various input/output signals as may be needed for configuration and diagnostic purposes.

It may be seen from the foregoing description that, in an embodiment, the invention provides for a robust method of mounting camera 18 over an analog gauge that nevertheless does not block direct physical viewing of the gauge. The camera 18 is in communication with a microcontroller 34 that provides for the onboard processing of the video signals from the camera 18. Housing 10 provides robust protection for these components, while legs 16 and the related components provide for a secure connection between the device and an analog gauge that may be of many different sizes.

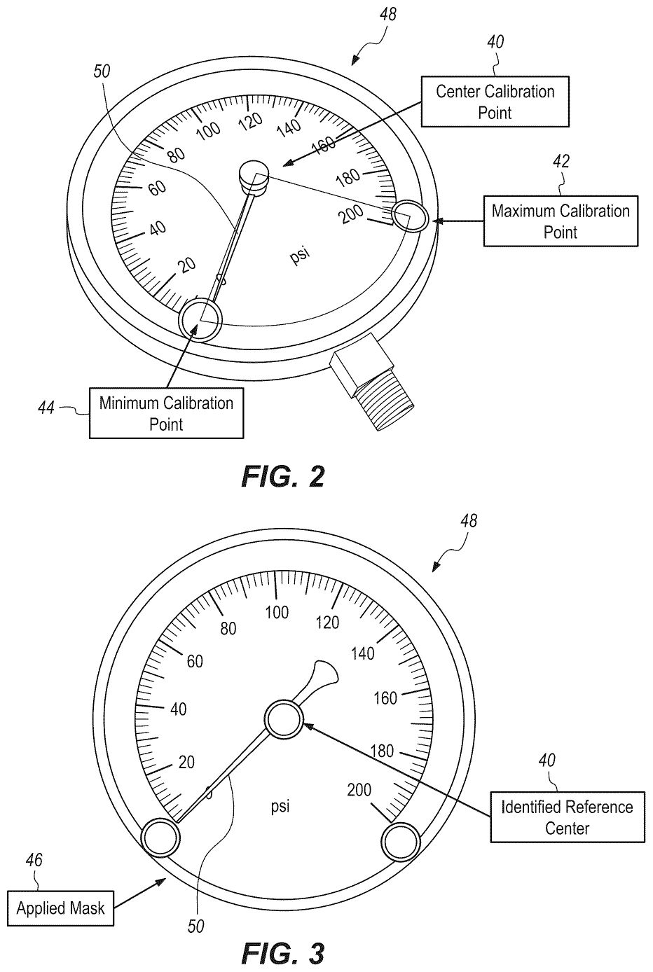

The physical structure of the device having been described, the method implemented by software within microcontroller 34 for reading an analog gauge 48 may now be described with reference to FIGS. 2-7. Because the device does not block the face of analog gauge 48, the method of reading the gauge must account for variations in lighting on the face of analog gauge 48. The gauge reader methodology relies on the placement of three reference points on the face of the gauge 48, as shown in the example of FIG. 2: center reference point 40; minimum calibration point 44, and maximum calibration point 42. This physical reference placement facilitates the calibration process and provides flexibility for the mounting in the likely case that the center of the image is not aligned to the reference-center.

In order to distinguish them in an image from camera 18, each of center calibration point 40, maximum calibration point 42, and minimum calibration point 44 may be different colors in certain embodiments. In the embodiment described herein, center calibration point 40 will be black, maximum calibration point 42 will be red, and minimum calibration point 44 will be green. Other colors could be used in alternative embodiments, as the invention is not so limited.

Still with reference to FIG. 2, The unshaded area of the gauge 48 periphery between minimum calibration point 44 and maximum calibration point 42 represents the viable range of angles within the gauge's operability. On the contrary, the shaded area of the gauge 48 corresponds to angles outside of gauge 48's value range, i.e., the area beyond maximum calibration point 42 and before minimum calibration point 44.

In overview, the premise of the reader subroutine is to identify the corresponding reference points, then compare the needle position in relation to the calibration points to translate the current value into terms of a range span. From a consecutive number of pictures, the device then determines a running average, and transmits that value wirelessly via standard Wi-Fi, Bluetooth, or other wireless communication methodologies. In an alternative embodiment, the device could communicate via a wired connection.

Throughout the process just described, microcontroller 34 checks to see if a file containing the last calibration exists, otherwise it is guided to self-calibrate. In the case that the file exists, the calibration is checked to determine if it remains current. If so, then the process skips to the gauge reading phase. This determination reduces the process time and improves battery life.

To begin the reading process, a subroutine for finding the center point stored in microcontroller 34 first collects a number of images from camera 18. For each image, the subroutine finds circular features within the image. If the center pixel of the feature is “black,” then the subroutine stores it. From these stored features, the subroutine determines the roundest, most reoccurring (i.e., most stable) feature. This is determined to be center calibration point 40. The subroutine then checks for changes of color to the left, right, top, and bottom from the reference pixel to determine if there is a transition onto white pixels, which symbolizes a reference dot. The subroutine applies centering corrections if needed and determines the radius. Then, the subroutine collects the pixels throughout the perimeter to determine a ratio of white pixels to dark pixels. If this ratio is above the imposed threshold, then the center coordinates are accepted.

Once the reference-center is determined in this way, the subroutine generates an applied mask 46 that extends radially by the maximum length or width of the image. This may be represented within the subroutine software as argmax ([length, width]). The shaded portion outside of the face of the gauge 48 is covered by the applied mask 46.

The subroutine relies on the center calibration point 40 being ideally round, with a black center and white outline; this facilitates the detection of circular feature which encompasses low pixel values in comparison to the lighter pixel values (i.e., the white-based background of gauge 48). The iterative collection of images generates a statistical validation process that the detected reference-center feature is stable and detectable, meaning that it is not adhering to a circular artifact that might be detected in one frame and not register in the next.

Once the reference-center is established, applied mask 46 removes the background field outside of the gauge 48 face, as shown in FIG. 3.

Next, the subroutine for determining the minimum and maximum reference locations is executed. First, this subroutine captures an image from camera 18. A copy of this image is then made, which is converted to black and white. Thus there are two images used for further processing, one in grayscale and one being the original color image. The subroutine obtains image statistics; if the image reflects low lighting (i.e., low upper-quartile pixel values), then the image is brightened by gamma color correction.

The subroutine runs iterative thresholding on the grayscale image starting from a value of 0 to 255 with sized thresholding window W. For each iterative threshold, the subroutine search for rounded features. If the feature's roundness is larger than a roundness threshold, and if the feature's center pixel value referencing the original image is approximately “green” or “red” in the original color image, and if the feature has a separation greater than a defined number of pixels in relation to the determined center, then the subroutine stores attributes into an appropriate reference dataset. The check on separation from the determined center is performed to remove the chance that the center is selected as a minimum/maximum calibration location.

The subroutine next retrieves a list of unique coordinates to remove duplicates, and performs a four-point and perimeter determination as shown in FIG. 3. If the calibration points pass the determination, then the values are accepted.

If the calibration points do not pass the determination, then the subroutine performs a series of steps for each red/green dataset. It first estimates the most reoccurring coordinates within a certain plus/minus threshold windowing distance, and filters the dataset. If there is data that satisfies these criteria from the filtered dataset, then the subroutine establishes the coordinates of the maximum calibration point 42 and minimum calibration point 44. Otherwise, the system reattempts the process, and continues doing so until a maximum set number of attempts are reached.

For both calibration colors, the subroutine performs centering corrections. First, it extracts locations of neighboring pixels in the vicinity that match the corresponding color until no further matches are obtained. It then estimates the average x and y position of the pixels to apply centering correction.

It may be understood that the objective of this subroutine is to identify the colored reference points by applying a range of thresholds, and if the center pixel of the features identified at the imposed thresholds contains a color match, then this is stored. Once the collection process is complete, the most frequent location is assigned for the corresponding reference point, this being green as the minimum and red as the maximum. If a minimum or maximum is not identified, then the attempt is tallied, and the process is repeated until both reference points are identified, or the maximum number of attempts is reached.

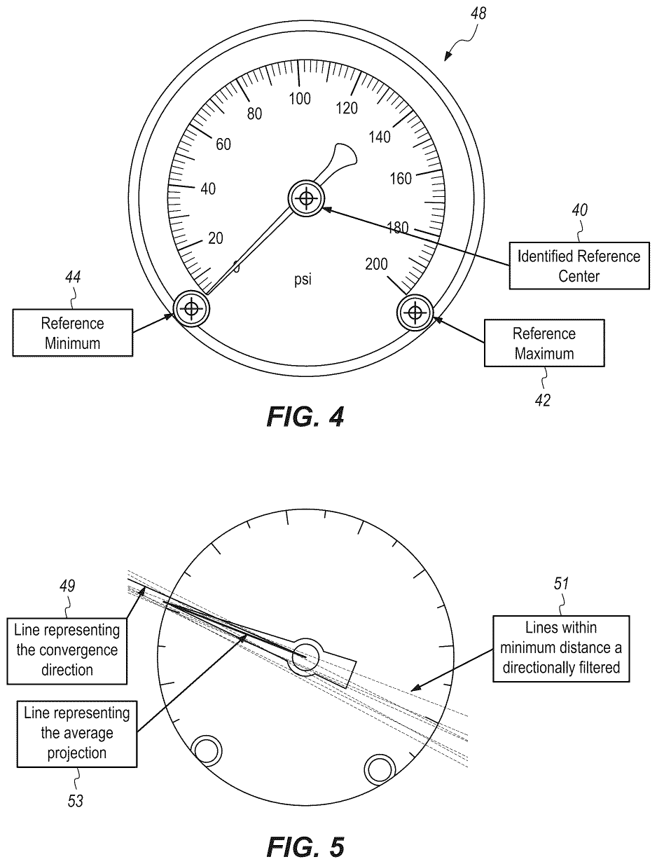

The comparison of the captured color is sensitive to the lighting conditions, which as explained above may vary because the face of gauge 48 is exposed to ambient light. For this reason, an array of various green and red hues are provided in order for the identified color to be compared under different lighting conditions. FIG. 4 depicts the outcome of the subroutine in which the minimum and maximum locations (maximum calibration point 42 and minimum calibration point 44) are determined.

In some cases, the device may be used with black background gauges with white needles. In such case, pixel values are first taken within two concentric circles of distance r and r+dr focused around the determined center. The median value of the pixel population is representative of the background color. The ratio between the median background color is then compared to the pixel at the center coordinate. If the ratio is relatively large (i.e., greater than 2.5) then the background is white, and the needle color is black. If the ratio is less than or equal to 2.5, then the background is very similar to the center calibration dot, which symbolizes a dark background and a white needle. The value of 2.5 was selected in an embodiment based on several tests conducted which accounted for low-lighting settings in which the white background results in relatively darkened pixels.

With these steps completed, another subroutine is called to determine the reading of needle 50 on analog gauge 48. Two different methods may be used for determining the reading of needle 50, in alternative embodiments, or an embodiment may provide the alternative of using either of the first and second methods.

In the first method for reading needle 50 on analog gauge 48, as illustrated in FIG. 5, the first step is to take an image from window 18. This image is converted to black and white. If the background is dark, then the image is converted to the negative to invert the high-low pixel values.

Next, the initial line-finding threshold value is passed into the subroutine. For each line identified, the minimum distance from the line to the center point is estimated. If the distance is below an imposed threshold, then the location is stored; otherwise, if at least two lines are not found, then the threshold is decreased and the system repeats the analysis using the lower threshold.

Once two or more lines are stored, then the subroutine filters for line directions by imposing radian constraint. Histograms of the line angles in relation to the center are obtained, and the highest coincidence direction within the radian constraint is obtained.

If the lines are not parallel, then the subroutine estimates the intersection points between all filtered lines. The average convergence point is estimated, in order to give guidance in what direction the lines converge. Then the intersection points of the lines is calculated onto the applied mask in the direction of the convergence point.

The average direction point a is estimated, as shown in FIG. 5. The subroutine collects the line integrals from the arc length with the average direction in the center; herein, the arc fan is described as θ. In addition, the subroutine collects the 180° (π) offset integrals in case the average projection is pointing in the backwards direction. The corresponding equations are:

$$- \frac{θ}{2} \leq α \leq \frac{θ}{2} \& π - \frac{θ}{2} \leq α \leq π + \frac{θ}{2}$$

With the collected image statistics, the subroutine determines the standard deviation (σ), lower (Q₁) and upper (Q₃) quartile values of the pixels. It then estimates the lower-range and upper-range cutoff in order to apply a pixel value weighting function, μ_{L} and μ_{U}, respectively:

$${μ}_{L} = {Q}_{1} + \frac{5}{6} σ$$

$${μ}_{U} = {Q}_{3} + \frac{3}{4} σ$$

The subroutine then generates a weighting function for pixel values that are greater than or equal to μ_{L} and less than or equal to μ_{U}. The objective of the weighting function is to penalize pixels that correspond to the background values. In this case the selected function is a Bezier curve, detailed as follows:

$$ρ = pixel value$$

$$C ( ρ ) = \frac{ρ - {μ}_{L}}{{μ}_{U} - {μ}_{L}} ;$$

normalized pixel value
δ=minimum value pull; this is variable but for the current algorithm it has a value of −7.

The subroutine then determines the Bezier curve weighting function:

$$ω ( t ) = {( 1 - t )}^{3} {P}_{0} + 3 {t ( 1 - t )}^{2} {P}_{1} + 3 {t}^{2} ( 1 - t ) {P}_{2} + {t}^{3} {P}_{3}$$

where P₀=1; P₁=1; P₂=δ; P₃=1.

These weighting functions are dynamic in nature as these are dependent on the lighting conditions which drive the input parameters.

Next, the subroutine estimates the line integral along the center to the arc. Here, the pixel values are inverted such that the low-value pixels (i.e., the black needle) have the higher contribution:

$${ε}_{θ} = \int ( 255 - ρ ) ω ( t ) d ρ$$

The normalized line integral is defined as:

$${\overline{ε}}_{θ} = \frac{{ε}_{θ}}{\int 2 \; 55 d ρ}$$

Here, the denominator represents the maximum integral value that the pixels could have. The collected integrals now reflect the angular projection from the center onto the arc location. This data is smoothed using an iterative average smoothing function; here the averaging window size is 5 data points and the number of iterations performed is 3.

The derivative is calculated along the angular direction and the sum of the absolute value is estimated; this is a cumulative representation of the variation in the direction. Being mindful that the 180° offset of the arc-fan is estimated, this results in two values being estimated. The direction of the gauge needle should reflect the largest variation, while the backside of the needle should not have a comparable amount of variation; the largest value determines the set of data that is selected as the needle direction. That is, the maximum value from the dataset corresponds to the needle corresponding angle to the needle direction, and the normalized value in the direction of the maximum as well as the corresponding 180° offset are used as acceptance criteria.

If the needle angle is determined in this manner, then the subroutine stores the threshold at which this occurred and uses it as an input value for the next estimation. If the threshold value does not yield results, then it is decreased by the subroutine and the analysis performed with the lower threshold. If the method cannot capture the needle location after a set number of attempts, then the subroutine performs the second method described below.

FIG. 5 shows the lines calculated using the first method. The line representing the convergence direction 49 is shown, together with multiples lines within a minimally directionally filtered distance 51, and the line representing the average projection 53.

In summary, the objective of this subroutine is to obtain an initial guess of where the most prominent lines in the image are clustering. From these, the average direction is calculated, which might point in the forward or backward direction of the needle. The angles that span in a fan centered about the average direction are used as line integrals to estimate the cumulative weighted pixel values along the lines connecting the center to the arc. The weighted function is designed to penalize pixels that correlate to values representative of the background, and reduces penalization for pixels corresponding to reflections, therefore driving the weight by pixels that belong to the dark needle. The line integration is performed for the forward and the 180° offset to ensure both sides of the needle are considered; this results in the collection of two datasets. The derivative of the line integrals is performed along the arc in order to estimate the variation for each dataset. The needle should contain that largest amount of variation due to the tapering nature of its geometry. The dataset with the largest variation is selected and the angle corresponding to the maximum is determined to be the direction of the needle. This process is performed iteratively by varying the thresholds to obtain an appropriate initial guess. If the threshold yields a positive needle direction determination, then the threshold is stored for the next pass. However, if the direction of the needle cannot be determined after several passes, then the backup method is used to estimate the needle direction.

In the second method for reading needle 50 on analog gauge 48, the first step is, again, to take an image from window 18. This image is also converted to grayscale. In at least some embodiments, a Laplacian filter is applied to sharpen edge features.

Once the image is ready, the subroutine performs radial sampling. To do this, it iterates radially from the reference-center, rₙ=rₙ₋₁+dr: where r₁=r_{center}+dr. For each radius rₙ=rₙ₋₁+dr, the subroutine assesses if the radius intercepts a linear feature 54. If there is an intercept, then the 3-pixel×3-pixel window surrounding the recorded (x, y) intercept of linear feature 54 is obtained.

For each pixel in the 3×3 window, the subroutine collects its coordinate if the pixel value is less than the threshold. The purpose for this step is to filter for preferential “dark” features and ignores lighter lines. The subroutine only accounts for new/unique pixel coordinates to avoid double counting. The subroutine then calculates the relative angle between the minimum calibration point 44, the center calibration point 40, and the pixel's coordinate.

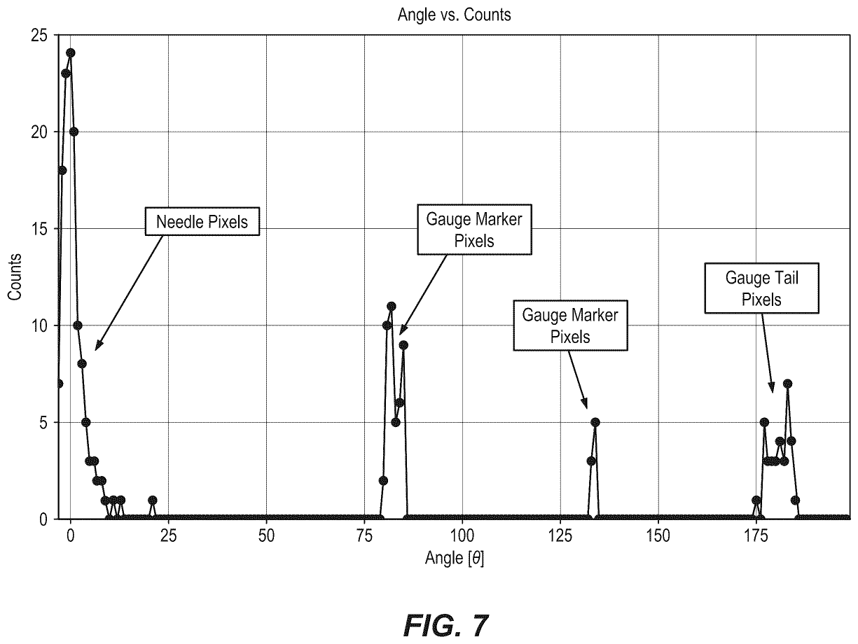

Once the radial sampling is complete, the subroutine proceeds to angular sampling. For Each angle θ_{N}=θ_{N-1}+dθ, the subroutine counts the number of pixels with relative angles less than θ_{N}. The system differentiates the counts in relation to angle to obtain the spectrum of pixel-counts versus angle, an example chart for which is shown in FIG. 7. The subroutine then estimates the area under each separate region of the curve as shown in FIG. 7. Needle 50 will coincide with the larger area of detected pixels.

Next, the subroutine identifies the range of angles that contain the largest area and retrieves the corresponding pixels. The subroutine generates a convex hull 52 that envelops the set of pixels, correlates the vertices of the convex-hull 52 to the corresponding angular counts, identifies the vertex with the highest coincidence-counts, and identifies the furthest point in the convex-hull 52.

To determine the needle direction, the subroutine then determines if the furthest point and the highest coincidence point are within de of each other; if so, then the subroutine selects the furthest point; otherwise, it selects the highest coincidence direction 56. The subroutine then checks if the line from the center to the determined point matches the color of the needle (using the corresponding color image).

As may be seen from the foregoing description, the objective of this subroutine is to analyze a snapshot of the gauge 48 to determine the direction of highest pixel-detection coincidence 56. This is performed by first sampling in the radial direction to generate a circle and collect any interceptions of linear features 54 that may have with any edge features in the image. The radius is then increased, and the next set of pixel intercepts is sampled. Radial sampling is complete once the maximum radius is reached.

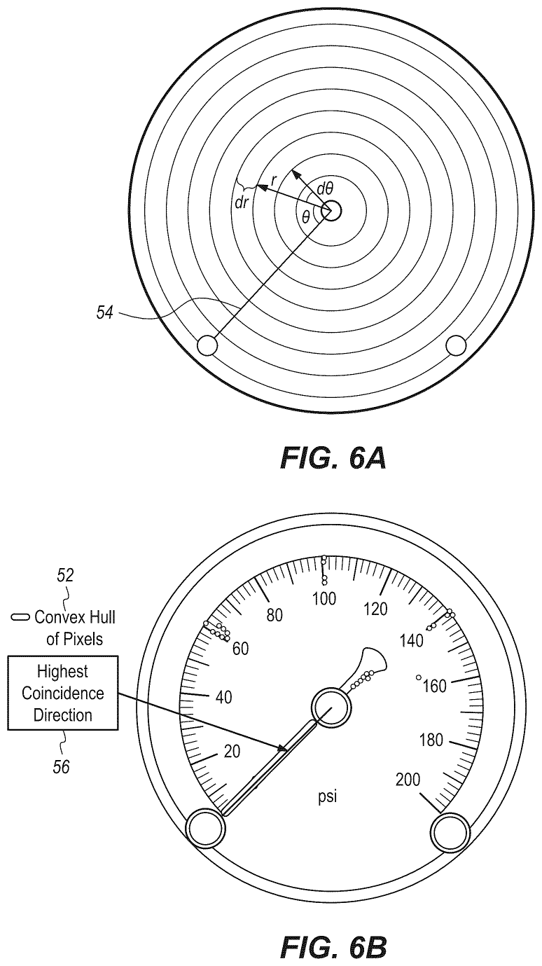

The angular sampling is next performed by counting the cumulative number of pixels bellow the imposed angle, with this angle being incrementally increased until the whole range of angles are sampled. The cumulative counts are then differentiated as a function of angle in order to provide a count vs angle relation; an example of this incremental radial and angular sampling in relation to the reference minimum and center points is depicted in FIG. 6a, while the graphic representation of this process is depicted by the blue pixels in FIG. 6b. Additionally, the result of the counts as a function of angle is depicted in FIG. 7.

The peaks in FIG. 7 represent distinct features, and the area under the curves represents the area covered by the detected pixels on said features. The anterior and posterior zero-valued plateaus are used to isolate the corresponding features. One can infer that the needle 50 represents the feature with the largest area due to its long-edge attributes and the large number of pixels identified through the radial-angular sampling.

The angles corresponding to the largest peak are extracted, and the pixels in this angular range are retrieved. The vertices of the convex-hull 52 are identified from the data-set, and the convex-hull 52 is the perimeter that encapsulates the pixels of interest.

The vertices are correlated to where they coincide on the counting curve, and the vertex of highest coincidence is selected. Additionally, the furthest vertex of the convex hull 52 is selected. The furthest and highest coincidence vertex are compared; if they are within a predetermined de threshold value, then the furthest is selected as the reading-value, otherwise the highest coincidence is reading-selected.

The angle of the direction to which the needle 50 is pointing is estimated in relation to the minimum calibration point 44 and the center calibration point 40. This calculation is then converted to gauge span range by comparing to the total gauge range in relation to the three calibration points.

The method as described herein for an embodiment of the invention has proven during testing to preferentially select the needle and marking attributes and bypass glare features that would otherwise result in erratic readings in various lighting conditions. Instances of false positives can occur in which a significant feature such as the tail of the needle may be selected due to lack of detections on the main body of the needle; however this is overridden by the consistency of the selection through repetition. The averaging process, as well as the outlier rejection process, are further described below.

Now that the value can be retrieved, consistency of values is relied upon to improve the certainty of the reading. In this case N readings are collected, where N can be any number as desired based on testing in a particular environment or with particular gauge 48 equipment. The percent readings are subjected to the same process of cumulative counting and differentiation to establish a spectrum of percent counts.

If there is a relatively large number of prior and posterior zero plateaus between values, then there are outlier values. The most probable needle reading value will have the largest counts (the area under the curve as shown in FIG. 7). If outliers are determined, then these values are rejected and new values are retrieved to compensate, given that the number of attempts to retrieve a new value are below the maximum number of attempts.

If the maximum number of attempts is reached, then the process is ended. Otherwise, the spectrum of values is within tolerance criteria, meaning they are similar, or at least they follow a sequence without a significant discontinuity. The values retrieved in this way can then be averaged and transmitted wirelessly in order to provide the gauge reading to a remote location in a digital format.

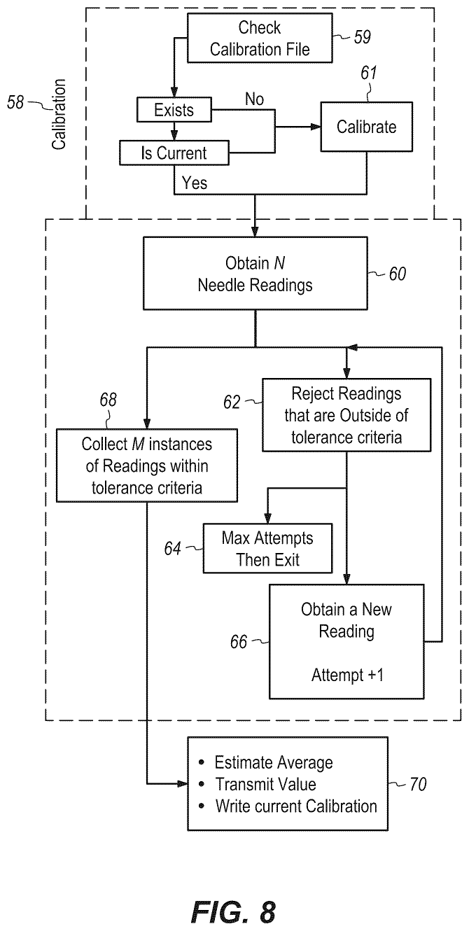

FIG. 8 depicts a high-level overview of the process used to determine accept/reject values and ultimately transmit a value or exit the process. At calibration step 58, the device is first calibrated in order to begin data analysis. At check calibration file sub-step 59, it is determined if a calibration file already exists. If not, then calibrate step 61 is executed; otherwise, processing moves on to data analysis since calibration is not needed.

At obtain readings step 60, a total of N (as described above) readings are obtained for the needle reading. Then, at reject readings step 62, any readings that are outside of tolerance criteria are rejected and not used.

If, at max attempts step 64, the maximum number of readings have already been taken, then the process exits and no further readings are obtained. If instead the maximum number of attempts have not been reached, then at obtain new readings step 66 a new reading is taken, and the number of attempts that have been made is incremented by one. Processing then returns to reject readings step 62.

Once a total number of M instances of readings within tolerance criteria are detected at collect readings step 68, then the data analysis portion of the process concludes. The estimated value for the gauge reading is then transmitted wirelessly from the device to an external receiver at transmit value step 70.

When the process is successful to calibrate and estimate a value, the calibration file is written to store the center, minimum, and maximum, and needle color details. This is used as a reference on the next read in order to check if the calibration remains valid. By maintaining this calibration file to check against, processing time is decreased, which also increases battery life for the device.

The wireless gauge reader as described herein may be a part of an overall system to provide wireless gauge readings throughout a plant, such as, in one non-limiting example, a nuclear power plant. Multiple wireless gauge readers are attached to analog gauges positioned at various desired positions within the plant. Each of the wireless gauge readers communicates with a remote monitoring station. The remote monitoring station provides a user with a reading from each of the gauges. The remote monitoring station including a user interface that makes clear to the operator the reading and particular gauge that is being read in the case of each reading. In this way a single operator may monitor any number of gauges that are found throughout the plant, the only limit being the number of wireless gauge readers that form a part of the overall monitoring system.

The remote monitoring station may further be configured to store gauge readings over time, thus creating a historical gauge reading set for each gauge that is being monitored. The remote monitoring station may thereby use this historical data to analyze trends in the gauge reading data. Furthermore, the remote monitoring station may be configured to generate alerts to the operator based on the gauge readings. These alerts may be based on a particular point of time (such as the gauge reading exceeding a particular target minimum or maximum) or based on the analysis of the historical data. The overall system thereby improves and supplements the ability of a user to appropriately monitor the operation of a plant for reasons such as safety and efficiency.

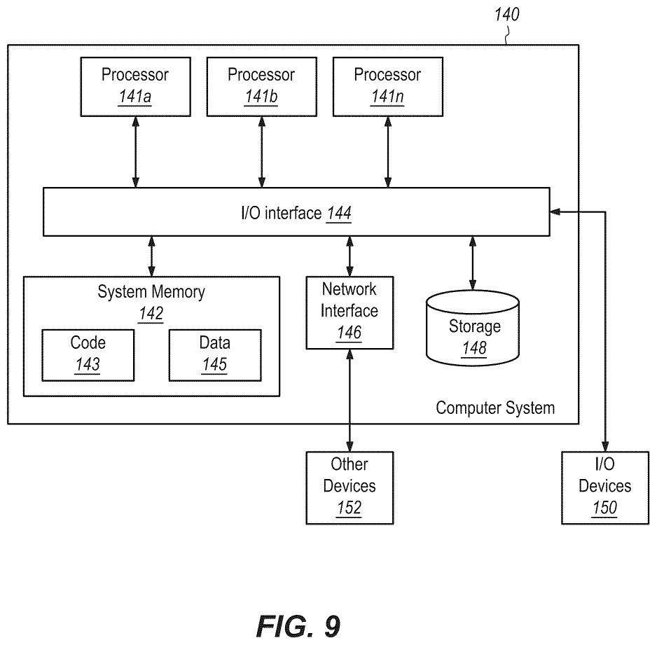

The methods described herein may in various embodiments be implemented by any combination of hardware and software. For example, in one embodiment, the methods may be implemented by a microcontroller (e.g., a microcontroller as in FIG. 9), a computer system, or a collection of computer systems, each of which includes one or more hardware processors executing program instructions stored on a computer-readable physical storage medium coupled to the hardware processors. The program instructions may implement the functionality described herein (e.g., the functionality of various hardware servers and other components that implement the network-based cloud and non-cloud computing resources described herein). The various methods as illustrated in the figures and described herein represent example implementations. The order of any method may be changed, and various elements may be added, modified, or omitted.

FIG. 9 is a block diagram illustrating an example microcontroller, according to various embodiments. Microcontroller 140 may implement a hardware portion of a cloud computing system or non-cloud computing system, as forming parts of the various implementations of the present invention. Microcontroller 140 may be any of various types of hardware devices, including, but not limited to, a commodity server, personal computer system, desktop computer, laptop or notebook computer, mainframe computer system, handheld computer, workstation, network computer, a consumer device, application server, physical storage device, telephone, mobile telephone, or in general any type of computing node, compute node, compute device, and/or hardware computing device.

Microcontroller 140 may include one or more hardware cores 141a, 141b . . . 141n coupled to a physical system memory 142 via an input/output (I/O) interface 144. Microcontroller 140 further may include a network interface 146 coupled to I/O interface 144. In various embodiments, microcontroller 140 may be a single processor system including one hardware processor 141a, or a multiprocessor system including multiple hardware processors 141a, 141b . . . 141n as illustrated in FIG. 9. The microcontroller 140 also includes one or more hardware network communication devices (e.g., network interface 146) for communicating with other systems and/or components over a communications network, such as a local area network, wide area network, or the Internet. For example, a client application executing on system 140 may use network interface 146 to communicate with a server application executing on a single hardware server or on a cluster of hardware servers that implement one or more of the components of the systems described herein in a cloud computing or non-cloud computing environment as implemented in various sub-systems. In another example, an instance of a server application executing on microcontroller 140 may use network interface 146 to communicate with other instances of an application that may be implemented on other computer systems. As noted above in the illustrative embodiment microcontroller communicates outside of the device wirelessly, but the invention is not so limited.

Microcontroller 140 may also include one or more physical persistent storage devices 148 and/or one or more I/O devices 150. In various embodiments, persistent storage devices 148 may correspond to disk drives, solid-state memory or drives, other mass storage devices, or any other persistent storage devices. Microcontroller 140 (or a distributed application or operating system operating thereon) may store instructions and/or data in persistent storage devices 148, as desired, and may retrieve the stored instructions and/or data as needed. For example, in some embodiments, microcontroller 140 may implement one or more nodes of a control plane or control system, and persistent storage 148 may include the solid-state drives (SSDs) attached to that server node.

Microcontroller 140 includes one or more physical system memories 142 that may store code/instructions 143 and data 145. The system memories 142 may include multiple levels of memory and memory caches in a system designed to swap information in memories based on access speed, for example. The interleaving and swapping may extend to persistent storage devices 148 in a virtual memory implementation, where memory space is mapped onto the persistent storage devices 148. The technologies used to implement the system memories 142 may include, by way of example, static random-access memory (RAM), dynamic RAM, read-only memory (ROM), non-volatile memory, solid-state memory, or flash-type memory. As with persistent storage devices 148, multiple computer systems 140 may share the same system memories 142 or may share a pool of system memories 142. System memory or memories 142 may contain program instructions 143 that are executable to implement the routines described herein.

In various embodiments, program instructions 143 may be encoded in binary, Assembly language, any interpreted language such as Java, compiled languages such as C/C++, or in any combination thereof; the particular languages given here are only examples. In some embodiments, program instructions 143 may implement multiple separate clients, server nodes, and/or other components.

In some implementations, program instructions 143 may include instructions executable to implement an operating system (not shown), which may be any of various operating systems, such as UNIX, LINUX, Solaris™, MacOS™, or Microsoft Windows™. Any or all of program instructions 143 may be provided as a computer program product, or software, that may include a non-transitory computer-readable storage medium having stored thereon instructions, which may be used to program a computer system (or other electronic devices) to perform a process according to various implementations. A non-transitory computer-readable storage medium may include any mechanism for storing information in a form (e.g., software or processing application) readable by a machine (e.g., a physical computer). Generally speaking, a non-transitory computer-accessible medium may include computer-readable storage media or memory media such as magnetic or optical media, coupled to or in communication with microcontroller 140 via I/O interface 144. A non-transitory computer-readable storage medium may also include any volatile or non-volatile media such as RAM or ROM that may be included in some embodiments of microcontroller 140 as system memory 42 or another type of memory. In other implementations, program instructions may be communicated using optical, acoustical or other form of propagated signals (e.g., carrier waves, infrared signals, digital signals, etc.) conveyed via a communication medium such as a network and/or a wired or wireless link, such as may be implemented via network interface 146. Network interface 146 may be used to interface with other devices 152, which may include other computer systems or any type of external electronic device.

In some embodiments, system memory 142 may include data store 145, as described herein. In general, system memory 142 and persistent storage 148 may be accessible on other devices 152 through a network and may store data blocks, replicas of data blocks, metadata associated with data blocks, and/or their state, database configuration information, and/or any other information usable in implementing the routines described herein.

In some embodiments, I/O interface 144 may perform any necessary protocol, timing or other data transformations to convert data signals from one component (e.g., system memory 142) into a format suitable for use by another component. In some embodiments, I/O interface 144 may include support for devices attached through various types of peripheral buses, such as a variant of the Peripheral Component Interconnect (PCI) bus standard or the Universal Serial Bus (USB) standard, as examples. Also, in some embodiments, some or all of the functionality of I/O interface 144, such as an interface to system memory 142, may be incorporated directly into processor(s) 141a, etc.

Network interface 146 may allow data to be exchanged between microcontroller 140 and other devices attached to a network, such as other computer systems (which may implement one or more storage system server nodes, primary nodes, read-only node nodes, and/or clients of the database systems described herein), for example. In addition, I/O interface 144 may allow communication between microcontroller 140 and various I/O devices 150 and/or remote storage 148. Multiple input/output devices 150 may be present in communication with microcontroller 140 or may be distributed on various nodes of a distributed system that includes microcontroller 140. In some embodiments, similar input/output devices may be separate from microcontroller 140 and may interact with one or more nodes of a distributed system that includes microcontroller 140 through a wired or wireless connection, such as over network interface 146. Network interface 146 may commonly support one or more wireless networking protocols (e.g., Wi-Fi/IEEE 802.11, or another wireless networking standard). Network interface 146 may support communication via any suitable wired or wireless general data networks, such as other types of Ethernet networks, for example. In various embodiments, microcontroller 140 may include more, fewer, or different components than those illustrated (e.g., displays, video cards, audio cards, peripheral devices, or an Ethernet interface).

Unless otherwise stated, all technical and scientific terms used herein have the same meaning as commonly understood by one of ordinary skill in the art to which this invention belongs.

Although any methods and materials similar or equivalent to those described herein can also be used in the practice or testing of the present invention, a limited number of the exemplary methods and materials are described herein. It will be apparent to those skilled in the art that many more modifications are possible without departing from the inventive concepts herein.

All terms used herein should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

When a grouping is used herein, all individual members of the group and all combinations and subcombinations possible of the group are intended to be individually included.

When a range is stated herein, the range is intended to include all sub-ranges within the range, as well as all individual points within the range.

When “about,” “approximately,” or like terms are used herein, they are intended to include amounts, measurements, or the like that do not depart significantly from the expressly stated amount, measurement, or the like, such that the stated purpose of the apparatus or process is not lost.

All references cited herein are hereby incorporated by reference to the extent that there is no inconsistency with the disclosure of this specification.

The present invention has been described with reference to certain preferred and alternative embodiments that are intended to be exemplary only and not limiting to the full scope of the present invention, as set forth in the appended claims.

1. A wireless gauge reader, comprising:
a housing;
a camera mounted within the housing;
a microcontroller coupled to the camera;
at least three telescoping legs hingeably connected to the housing, wherein each of the at least three telescoping legs comprises a leg cam extending from an underside of each such leg; and
a leg adjustment mechanism configured to synchronously adjust the three telescoping legs, wherein the leg adjustment mechanism comprises a leg adjustment ring threaded to the housing at a gauge side of the housing and engaging with the leg cam on each of the at least three telescoping legs,
wherein the reader is configured to mount on an analog gauge and capture images of the analog gauge face for digital processing.

2. The wireless gauge reader of claim 1, wherein each of the at least three telescoping legs comprises:
an upper leg portion;
a lower leg portion; and
a locking nut connecting the upper leg portion and the lower leg portion, the locking nut configured to adjust a total length of each of the at least three telescoping legs.

3. The wireless gauge reader of claim 2, further comprising a foot attached at the end of each of the at least three telescoping legs, the foot configured to engage with an edge of the face of the analog gauge.

4. The wireless gauge reader of claim 3, further comprising a window positioned between the camera and the face of the analog gauge to protect the camera.

5. The wireless gauge reader of claim 4, further comprising a housing cap movably attached to the housing to provide access to the microcontroller.

6. The wireless gauge reader of claim 5, further comprising an antenna channel housing an antenna attached to the microcontroller for wireless communication between the microcontroller and a remote device.

7. The wireless gauge reader of claim 6, further comprising a connection port in the housing allowing direct wired connections to the microcontroller from outside of the housing.

8. A method for reading an analog gauge using a wireless gauge reader device, the method comprising:
capturing an image of an analog gauge face of the analog gauge using a camera mounted within the wireless gauge reader device;
identifying a center calibration point, a maximum calibration point, and a minimum calibration point on the analog gauge face;
detecting a position of a needle on the analog gauge face;
determining a gauge reading based on the detected needle position relative to the calibration points; and
wirelessly transmitting the determined gauge reading to a remote device.

9. The method of claim 8, wherein the step of identifying the center calibration point comprises the steps of:
collecting a plurality of images of the analog gauge face;
detecting circular features within each image;
identifying at least one predetermined calibration feature from among the detected circular features; and
determining the most stable and reoccurring predetermined calibration feature as the center calibration point.

10. The method of claim 9, wherein the step of identifying the maximum and minimum calibration points comprises the steps of:
capturing a color image of the analog gauge face;
converting the color image to a black-and-white image; and
performing iterative thresholding on the black-and-white image.

11. The method of claim 10, wherein the step of identifying the maximum and minimum calibration points further comprises the steps of:
detecting rounded features at each of a plurality of threshold levels;
identifying features with center pixel values corresponding to predetermined colors in the color image; and
determining the most frequently occurring coordinates for each predetermined color as the maximum and minimum calibration points.

12. The method of claim 11, wherein the step of detecting the position of the needle comprises the steps of:
performing radial sampling from the center calibration point to detect linear features;
performing angular sampling to count detected pixels at different angles;
generating a pixel count versus angle spectrum;
identifying a range of angles containing the largest area under the spectrum curve; and
determining the needle direction based on the identified range of angles.

13. The method of claim 12, further comprising the steps of:
obtaining multiple gauge readings;
rejecting outlier readings based on predetermined tolerance criteria;
averaging the remaining gauge readings; and
wirelessly transmitting the averaged gauge reading.

14. A system for remotely monitoring analog gauges, comprising:
a plurality of wireless gauge readers, each wireless gauge reader comprising:
a housing;
a camera mounted within the housing;
a processor coupled to the camera;
a plurality of telescoping legs connected to the housing;
a leg adjustment mechanism configured to synchronously adjust the plurality of telescoping legs; and
a wireless communication module connected to the processor;
wherein each wireless gauge reader is configured to mount on an analog gauge, capture images of a gauge face of the analog gauge, process the images to determine a gauge reading, and wirelessly transmit the gauge reading; and
a remote monitoring station configured to receive and display the gauge readings from each of the plurality of wireless gauge readers.

15. The system of claim 14, wherein the processor in each of the plurality of wireless gauge readers comprises programming configured to:
identify a plurality of calibration points on the gauge face;
detect a position of a needle on the gauge face;
determine a gauge reading based on the detected needle position relative to the calibration points; and
control the wireless communication module to transmit the determined gauge reading.

16. The system of claim 15, wherein the remote monitoring station is further configured to:
store historical gauge readings from each wireless gauge reader;
analyze trends in the historical gauge readings; and
generate alerts based on predetermined criteria.

17. The system of claim 16, wherein each of the plurality of telescoping legs comprises a leg cam, and further wherein the leg adjustment mechanism engage with the leg cam on each of the plurality of telescoping legs.

18. A method for reading an analog gauge using a wireless gauge reader device, the method comprising:
capturing an image of an analog gauge face using a camera mounted within the wireless gauge reader device;
performing an iterative threshold to identify at least one most prominent line feature in the image;
estimating a minimum distance from a center of the at least one most prominent line to a center point of the analog gauge;
filtering for a direction of the at least one most prominent line by applying a radian constraint;
estimating an average-projected point to produce a reading; and
returning the reading to a remote device.

19. The method of claim 18, wherein the step of performing an iterative threshold to identify at least one most prominent line feature in the image comprises the steps of:
estimating a minimum distance from the at least one most prominent line to a center point of the analog gauge;
if the minimum distance is below an imposed threshold, storing the minimum distance;
if the at least one most prominent line does not compose at least two most prominent lines, decreasing the imposed threshold and repeating the step of performing an iterative threshold to identify at least one most prominent line feature in the image;
applying a weighting function to penalize background pixels; and
determining at least one prominent line feature using arc intervals and a highest coincidence.

20. The method of claim 19, wherein the step of filtering for a direction of the at least one most prominent line by applying a radian constraint comprises the steps of:
if the at least two most prominent lines are not parallel, estimating a set of intersection points between the at least two most prominent lines;
estimating an average convergence point for the at least two most prominent lines;
applying the set of intersection points of the at least two most prominent lines onto a mask of the analog gauge in the direction of the average convergence point; and
checking if a line at a center of the average convergence point matches a needle color.
